(19) United States
(12) Patent Application Publication
(10) Pub. No.: US 2009/0095924 A1
(43) Pub. Date: Apr. 16, 2009

(54) ELECTRODE DESIGN FOR EUV DISCHARGE PLASMA SOURCE

(75) Inventors: Kurt R. Kimmel, Radelbeul (DE); Chiew-seng Koay, Guilderland, NY (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/871,440

(22) Filed: Oct. 12, 2007

(51) Int. Cl. G01J 1/00

(52) U.S. Cl. 250/504 R

(57) ABSTRACT

An apparatus for producing an extreme ultraviolet (EUV) discharge includes a metal source, a laser that produces a focused laser beam, and electrode operatively coupled to the metal source. The electrode includes a plurality of discrete metal retaining zones that deliver a controlled volume of metal into the focused laser beam to produce an EUV discharge plasma.

### BACKGROUND OF THE INVENTION

1. Field of the Invention

In general, the present invention pertains to the art of electrodes for semiconductor manufacture and, more particularly, to an electrode design for an extreme ultraviolet (EUV) discharge plasma source.

2. Description of the Related Art

As semiconductor manufacturing continues to produce features of reduced size, light sources having reduced wavelengths are needed. For example, research in photolithography as well as metrology has sought to produce reliable sources of wavelengths between about 31 nanometers (nm) to about 1 nm. Such wavelengths are generally referred to as “extreme ultraviolet” or EUV radiation. Currently, there are two main technologies for providing EUV. One technology is referred to as “laser produced plasma” (LPP) and a second or competing technology is referred to as “discharge produced plasma” (DPP).

A number of problems have emerged during the development of production quality sources of EUV. For example, a number of laser produced plasma (LPP) sources suffer from physics constraints associated with coupling a laser pulse energy into a fuel without some EUV being self-absorbed by the plasma or the laser being reflected by the plasma. Discharge produced plasma (DPP) sources experienced a problem with excessive debris emanating from the plasma. The excessive debris, in the form of highly energetic ions, atoms, and neutrals can damage downstream components, such as collector optics. Debris problems are also exhibited by LPP sources.

Current state-of-the DPP architecture has the advantage of relative simplicity and a massive electrode design which is advantageous for thermal management. However, this design suffers from a plasma fuel delivery that creates excessive debris. The current fuel of choice is tin due to its high conversion efficiency to 13.5 nm photons. The tin is melted and coated onto the electrode and ignited into a plasma using a laser trigger. The current design does not efficiently consume the tin fuel which results in excess tin being ejected from the discharge area. The excess tin coats the collector optics and foil trap which then degrades performance of the collector and creates discharges in the trap which, over time, causes serious reliability problems. The excess fuel limits both an ability to ramp-up power and to achieve reliable operation.

### BRIEF SUMMARY OF THE INVENTION

In accordance with a first aspect of the present invention, an apparatus for producing an extreme ultraviolet (EUV) plasma source is provided. The apparatus includes a metal source, a laser that produces a focused laser beam and an electrode. The electrode includes a plurality of discrete metal retaining zones that deliver a controlled volume of metal from the metal source into the focused laser beam to produce an EUV discharge plasma.

In accordance with the second aspect of the present invention, an electrode for use in an extreme ultraviolet (EUV) discharge plasma source is provided. The electrode includes a plurality of discrete metal retaining zones each of which is adapted to deliver a controlled volume of metal into a focused laser beam to produce an EUV discharge plasma.

In accordance with a third aspect of the present invention, a method of producing an extreme ultraviolet (EUV) discharge plasma is provided. The method includes rotating an electrode having a plurality of discrete metal retaining zones, collecting a controlled volume of metal at each of the plurality of discrete metal retaining zones and passing the controlled volume of metal at each of the plurality of discrete metal retaining zones through a focused laser beam to produce an extreme ultraviolet (EUV) plasma discharge.

At this point it should be appreciated that the various aspects of the present invention provide an apparatus for collecting and passing a controlled volume of metal through a focused laser beam. The controlled volume of metal is ignited to form an EUV discharge plasma with virtually no excess metal remaining to form debris that could damage various components of the apparatus. Additional features and advantages are realized through the techniques of the present invention. Other embodiments and aspects of the invention are described in detail herein and are considered a part of the claimed invention. For a better understanding of the invention with advantages and features, refer to the description and to the drawings. It is intended that all such additional objects, features and advantages be included within this description, are within the scope of the present invention can be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic representation of an apparatus for producing an extreme ultraviolet (EUV) plasma discharge including an electrode having a plurality of discrete metal retaining zones constructed in accordance with a first aspect of the present invention;

FIG. 2 is a partial detail view of the electrode of FIG. 1;

FIG. 3 is a lower right perspective view of an electrode including a plurality of discrete metal retaining zones constructed in accordance with a second aspect of the present invention;

FIG. 4 is a lower right perspective view of electrode including a plurality of discrete metal retaining zones constructed in accordance with the third aspect of the present invention;

FIG. 5 is a perspective view of one of the plurality of discrete metal retaining zone of the electrode of FIG. 4; and

FIG. 6 is a partial detail view of the electrode of FIG. 1 collecting a controlled volume of metal from a metal foil in accordance with yet another aspect of the present invention.

### DETAILED DESCRIPTION OF THE INVENTION

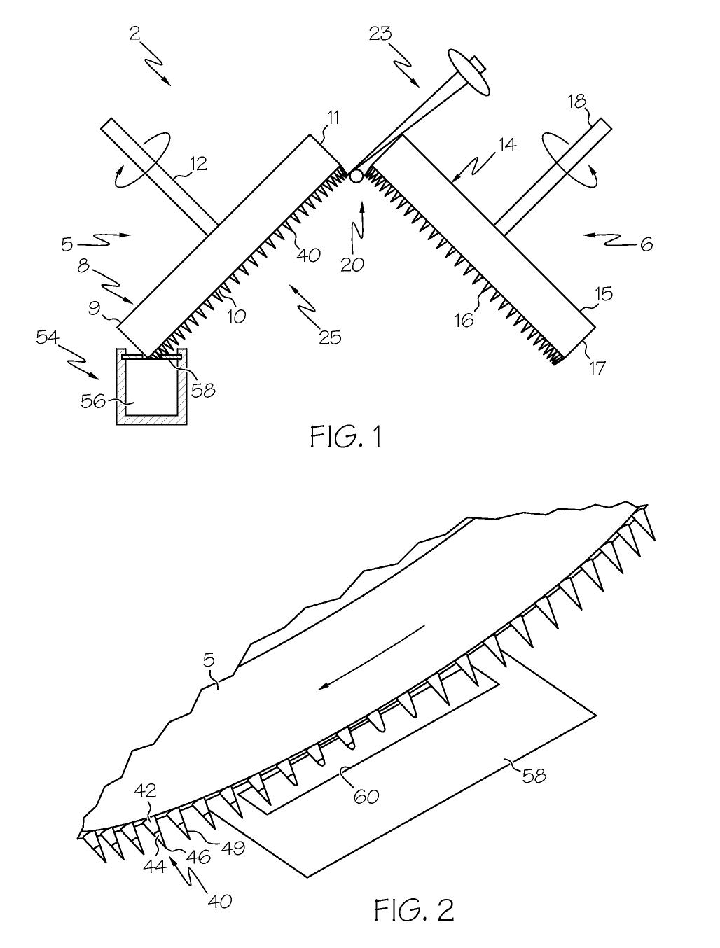

With initial reference to FIG. 1, an extreme ultraviolet (EUV) plasma discharge apparatus constructed in accordance with a first aspect of the present invention is generally indicated at 2. As shown, apparatus 2 includes a first electrode 5 and a second electrode 6. First electrode 5 includes a main body 8 having an upper surface 9, a lower surface 10, and a peripheral edge 11. An axle 12 extends from upper surface 9 and defines an axis of rotation for first electrode 5. In a similar manner, second electrode 6 includes a main body 14 having an upper surface 15, a lower surface 16, and a peripheral edge 17. An axle 18 extends from upper surface 15 and defines an axis of rotation for second electrode 6. First and second electrodes 5 and 6 are positioned in a spaced relationship so as to define a gap 20 between peripheral edge 11 and peripheral edge 17. As will be discussed more fully below, a laser (not separately labeled), such as a Nd: YAG laser for example, that produces a focused beam 23 at approximately 1064 nm that is delivered into gap 20. However, it should be understood that other lasers, such as CO₂ lasers producing a 10 micron beam can also be employed. In accordance with the aspect shown, each electrode 5, 6 is provided with a plurality of discrete metal retaining zones (indicated generally at 25) on first electrode 5.

As best shown in FIG. 2, each of the plurality of discrete metal retaining zones 25 is constituted by a spike 40. Spike 40 includes a generally rounded base portion 42 that extends through a conical intermediate portion 44 to a tip portion 46. In the exemplary embodiment shown in FIGS. 1 and 2, tip portion 46 has a diameter that is preferably less than 40 μm in size. More preferably, tip portion 46 is less than 25 μm in diameter. Most preferably, tip portion 46 is 10 μm or smaller. However, it should be understood that the size of tip portion 46 can vary in accordance with the present invention. In any event, spike 40 is configured to retain a controlled volume of metal 49. More specifically, as electrode 5 is rotated about the axis defined by axle 12, spike 40 is immersed into a metal bath 54 containing a liquid metal fuel 56. As shown, metal bath 54 includes a cover 58 having a slotted opening 60. Cover 58 is selectively positioned to establish a particular immersion depth for spike 40. In this manner, controlled volume of metal 49 can be selectively varied to accommodate a desired application. In any event, after immersion in liquid metal fuel 56, spike 40 is rotated to gap 20. At this point, the laser is triggered to direct focused laser beam 23 onto controlled volume of metal 49. The controlled volume of metal is ignited to produce the EUV discharge plasma.

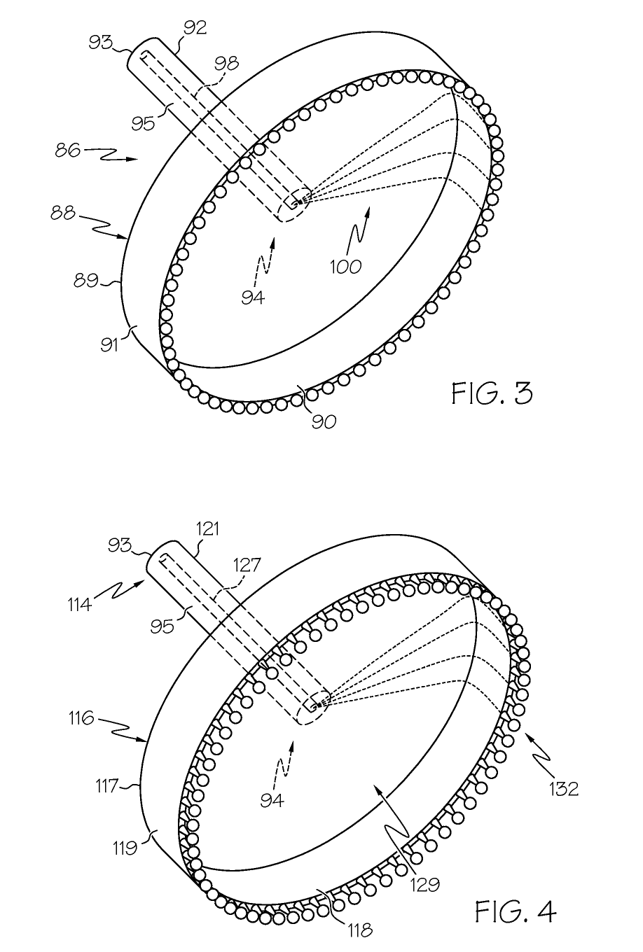

Reference will now be made to FIG. 3, in describing an electrode 86 constructed in accordance with a second aspect of the present invention. As shown, electrode 86 includes a main body 88 having an upper surface 89, a lower surface 90, and a peripheral edge 91. In a manner similar to that described above, electrode 86 includes an axle 92 that defines an axis of rotation. Axle 92 includes a first end 93 that extends to a second end 94 through an intermediate portion 95. First end 93 is in fluid communication with a metal source (not shown) with second end 94 being secured to upper surface 89 of electrode 86.

In accordance with the aspect shown, axle 92 includes a main supply channel 98 that extends between first and second ends 93 and 94. Main supply channel 98 is fluidly connected to a plurality of metal delivery passages or channels indicated at 100. Each of the plurality of metal delivery channels 100 includes a corresponding plurality of openings, such as indicated at 103. With this configuration, liquid metal is channeled through main supply channel 98 and delivered to each of the plurality of metal delivery channels 100 causing a controlled volume of metal to emerge from each opening 103. As electrode 86 is rotated, the controlled volume of metal at each opening 103 is passed through focused laser beam 23 to produce an extreme ultraviolet (EUV) plasma discharge.

Reference will now be made to FIG. 4, in describing a third embodiment of the present invention. As shown, an electrode 114 includes a main body 116 having an upper surface 117, a lower surface 118 and a peripheral edge 119. In a manner similar to that described above an axle 121 extends from upper surface 117 to define an axis of rotation for electrode 114. Axle 121 includes a first end 123 that extends to a second end 124 through an intermediate portion 125. First end 123 is in fluid communication with a source of metal (not shown) while second end 124 is secured to upper surface 117. In a manner also similar to that described above, axle 121 is provided with a main supply channel 127 that is fluidly connected to a plurality of metal delivery passages or channels indicated generally at 129. Each of the plurality of metal delivery channels 129 is fluidly connected to a corresponding plurality of metal retaining zones indicated generally at 132.

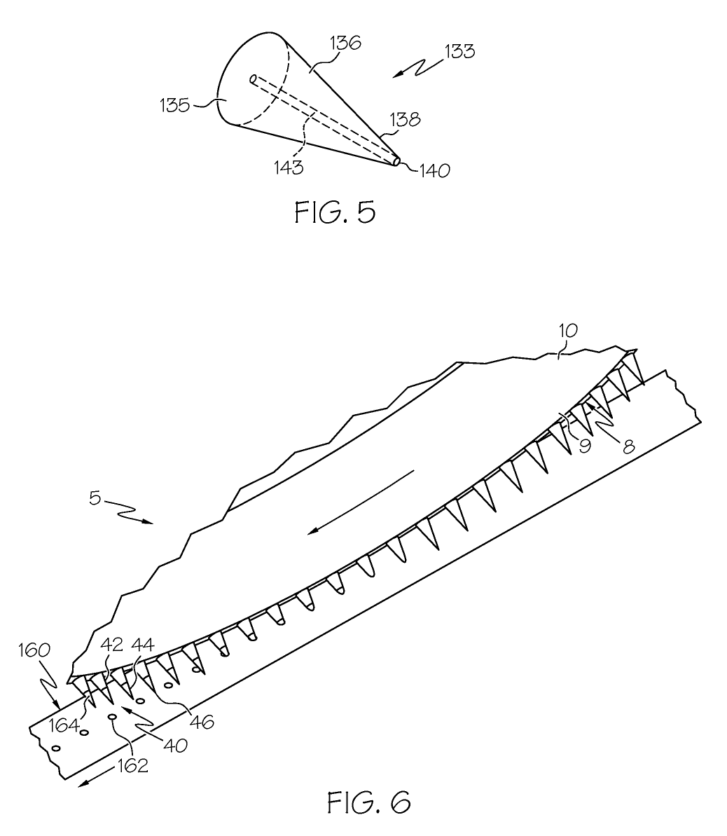

In accordance with the embodiment shown, metal retaining zones 132 are constituted by spikes one of which is illustrated at 133 in FIG. 5. As each of the plurality of metal retaining zones 132 is identical, a detailed description will follow referencing metal delivery zone or spike 133 with an understanding that each of the plurality of metal retaining zones 132 is similarly constructed. As shown, spike 133 includes a base portion 135 and that extends through a tapering or conical intermediate portion 136 to a tip portion 138 having an opening 140 formed therein. Spike 133 includes a central passage 143 that extends from a corresponding one of the plurality of metal delivery channels 129 to opening 140. In this configuration, liquid metal is passed through main supply channel 127 into each of the plurality of metal delivery channels 129. The liquid metal then passes into each of the plurality of metal retaining zones 132 allowing a controlled volume of metal to emerge from, for example, opening 140. As electrode 114 is rotated about the axis defined by axle 121, each controlled volume of metal is passed through focused laser beam 23 and ignited to form an extreme ultraviolet (EUV) plasma discharge. Of course it should be understood that while the exemplary embodiment describes the metal retaining zones as spike, various other shapes can be employed depending upon the desired size of the controlled volume of metal.

Reference will now be made to FIG. 6 in describing yet another aspect of the present invention. In addition to providing the controlled volume of metal on each metal retaining zone, from metal bath 54, the controlled volume of metal is supplied from a metal foil tape 160. More specifically, as first electrode 5 is rotated about the axis defined by axle 12, each metal retaining zone 40 is brought into contact with and punctures metal foil tape 160 to forms a respective opening 162. The depth of penetration into metal foil tape 160 determines the size of opening 162 and, by extension, the amount of the controlled volume of metal 164 deposited on metal retaining zone 40. Once coated with metal, metal retaining zones are passed through focused laser beam 23 and to produce an EUV discharge plasma.

At this point it should be appreciated that the present invention embodiments provide an apparatus for passing a controlled volume of liquid metal through a focused laser beam that is ignited to form an extreme ultraviolet (EUV) plasma discharge. The controlled volume is selectively controlled to ensure that no debris remains after the controlled volume is ignited. In this manner, the present invention embodiments ensure that adjacent structure(s) is not damaged by debris without requiring for additional structure such as screens, shields and the like.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. The present invention should only be limited by the scope of the following claims.

What is claimed is:

1. An apparatus for producing an extreme ultraviolet plasma source comprising:
a metal fuel;
a laser producing a focused laser beam; and
an electrode operatively coupled to the metal fuel, the electrode including a plurality of discrete metal retaining zones, each of the plurality of discrete metal retaining zones delivering a controlled volume of metal into the focused laser beam to produce an EUV discharge plasma.

2. The apparatus according to claim 1, wherein the electrode includes a main body having an upper surface, a lower surface and a peripheral edge that collectively define a disc, the plurality of discrete metal retaining zones being arranged in a spaced relationship about an outer perimeter of the peripheral edge.

3. The apparatus according to claim 2, wherein each of the plurality of discrete metal retaining zones is a spike projecting perpendicularly outward from the lower surface of the disc.

4. The apparatus according to claim 3, wherein the spike has a generally round base portion that transitions to a tip portion, the tip portion retaining a controlled volume of metal for delivery into the focused laser beam.

5. The apparatus according to claim 4, wherein the tip portion is less than approximately 40 μm in diameter.

6. The apparatus according to claim 2, wherein the electrode includes a main supply channel fluidly connected to a plurality of metal delivery channels, each of the plurality of metal delivery channels being fluidly connected to a corresponding one of the plurality of metal retaining zones.

7. The apparatus according to claim 6, wherein each of the plurality of discrete metal retaining zones is an opening arranged in a spaced relationship about an outer perimeter of the peripheral edge, the opening retaining a controlled volume of metal for delivery to the focused laser beam.

8. The apparatus according to claim 6, wherein each of the plurality of discrete metal retaining zones is a spike having a base portion that transitions to a tip portion having an opening formed therein, the spike having a central passage that leads from a corresponding one of the plurality of delivery channels to the opening, with the opening retaining a controlled volume of metal for delivery to the focused laser beam.

9. The apparatus according to claim 1, wherein the metal fuel is a metal foil, each of the plurality of discrete metal retaining zones being brought into contact with the metal foil to collect a controlled volume of metal.

10. An electrode for use in an extreme ultraviolet EUV discharge plasma source, the electrode comprising:
a plurality of discrete metal retaining zones, each of the plurality of discrete metal retaining zones being adapted to deliver a controlled volume of metal into a focused laser beam to produce a EUV discharge plasma.

11. The electrode according to claim 10, wherein the electrode includes a main body having an upper surface, a lower surface and a peripheral edge that collectively define a disc, the plurality of discrete metal retaining zones being arranged in a spaced relationship about an outer perimeter of the peripheral edge.

12. The electrode according to claim 11, wherein each of the plurality of discrete metal retaining zones is a spike projecting perpendicularly from the lower surface of the disc.

13. The electrode according to claim 12, wherein the spike has a base portion that transitions to a tip portion, the tip portion retaining a controlled volume of metal for delivery into the focused laser beam.

14. The electrode according to claim 13, wherein the tip portion is less than approximately 40 μm in diameter.

15. The electrode according to claim 11, wherein the electrode includes a main supply channel fluidly connected to a plurality of metal delivery channels, each of the plurality of metal delivery channels being fluidly connected to a corresponding one of the plurality of metal retaining zones.

16. The electrode according to claim 15, wherein each of the plurality of discrete metal retaining zones is an opening arranged in a spaced relationship about an outer perimeter of the peripheral edge, the opening retaining a controlled volume of metal for delivery to the focused laser beam.

17. The electrode according to claim 15, wherein each of the plurality of discrete metal retaining zones is a spike having a base portion that transitions to a tip portion having an opening formed therein, the opening retaining a controlled volume of metal for delivery to the focused laser beam.

18. A method of producing an extreme ultraviolet discharge plasma comprising:
rotating an electrode provided with a plurality of discrete metal retaining zones;
collecting a controlled volume of metal from a source of metal fuel at each of the plurality of discrete metal retaining zones; and
passing the controlled volume of metal at each of the plurality of discrete metal retaining zones through a focused laser beam to produce an extreme ultraviolet plasma discharge.

19. The method of claim 18, wherein the plurality of discrete metal retaining zones is constituted by a plurality of spikes extending from an outer peripheral edge of the electrode, wherein the controlled volume of metal is collected on each of the plurality of spikes.

20. The method of claim 18, wherein each of the plurality of discrete metal retaining zones comprises an opening formed at an outer peripheral edge of the electrode, wherein the controlled volume of metal is passed through the electrode and deliver to each opening.
